(19) United States
(12) Patent Application Publication
(10) Pub. No.: US 2007/0103088 A1
(43) Pub. Date: May 10, 2007

(54) STARTUP METHOD FOR THE MERCURY-FREE FLAT-FLUORESCENT LAMP

(75) Inventors: Chun-Hui Tsai, Hsinchu (TW); Jin-Chyuan Hung, Hsinchu City (TW); Chang-Chun Hsiao, Yunlin County (TW); Yui-Shin Fran, Hsinchu City (TW)

Correspondence Address: J C PATENTS, INC., 4 VENTURE, SUITE 250, IRVINE, CA, 92618, US

(73) Assignee: DELTA OPTOELECTRONICS, INC., Hsin-Chu (TW)

(21) Appl. No.: 11/461,545

(22) Filed: Aug. 1, 2006

(30) Foreign Application Priority Data
Nov. 8, 2005 (TW) 94140558

(51) Int. Cl. G05F 1/00

(52) U.S. Cl. 315/194

(57) ABSTRACT

A startup method for a mercury-free flat-fluorescent lamp is provided, which comprises providing a train of voltage pulses for driving the lamp; and changing the duty circle, switching frequency, and/or operation voltage level of the driven voltage pulse during the startup period of the lamp. The above factors are properly combined to achieve the rapid ignition, the uniform light up, and the lower startup current.

### CROSS-REFERENCE TO RELATED APPLICATION

This application claims the priority benefit of Taiwan application serial no. 94140558, filed on Nov. 18, 2005. The entirety of each of the above-mentioned patent application is hereby incorporated by reference herein and made a part of this specification.

### BACKGROUND OF THE INVENTION

1. Field of Invention

The present invention relates to a startup method for a mercury-free flat-fluorescent lamp, more particularly to a startup method for a mercury-free flat-fluorescent lamp with the advantages of rapid ignition, uniform light-up, and lower startup current.

2. Description of Related Art

In typical driving method, the cold cathode flat-fluorescent lamps are driving by using sinusoidal waveforms, as shown in FIG. 1. FIG. 1 is the measured voltage 120 and current 110 waveforms of the lamp. However, the driving circuit needs to provide the extremely large circulating energy by using a sinusoidal driving scheme. The circulating current flows through the driving circuit and the lamp glass resulting in a large power loss, which not only reduces the light luminous efficiency of the lamp, but also increases the temperature of the lamp.

Since a flat-fluorescent lamp has high impedance when not yet being ignited; the fluorescent lamp can be ignited by a resonance method. Unfortunately, the driving circuit can not work at a startup state for a long time, because of the high circulating current is generated by resonance, resulting in a damage of driving circuit. Hence, the driving circuit needs to design an output open-circuit protection to prevent the lamp from being disconnected or cracked. In the prior art, to reduce a high circulating current, a variable frequency control scheme is adopted. However, it is difficult to design optimal magnetic components, which would increase switching loss, cost and control complexity. On the other hand, since the flat-fluorescent lamp has a a large area, it is difficult for lighting up rapidly, uniformly, and simultaneously, resulting in an uneven luminance using the resonance method.

To solve this problem, an improved method issued by OSRAM Company is that, changing the switching frequency and being incorporated in the burst mode dimming, so as to uniformly light up the mercury-free flat-fluorescent lamp. For example, FIG. 2 illustrates the startup by way of a burst mode dimming. As shown in FIG. 2, a state of stable light-up is achieved after the burst mode dimming is carried out for several times. The experimental result of a small section 210 is zoomed out, and then it is a burst mode dimming sequence as shown in 210A. FIG. 3 illustrates the startup by way of a variable frequency control, in which, it is decreasing the operational frequency of driver in start-up period as shown in 310, and the normal operational frequency of driver is shown in 320. However, this method has the disadvantages of a high startup current, easy saturation of the magnetic element, and the load being incapable to be opened. Additionally, the lamp often fails to be ignited accurately and rapidly, since a period of time is required to raise the voltage from a low potential to a light-up voltage by a resonance.

### SUMMARY OF THE INVENTION

An object of the present invention is to provide a startup method for a mercury-free flat-fluorescent lamp, which is used for the rapid ignition and the uniform light-up.

Another object of the present invention is to provide a startup method for a mercury-free flat-fluorescent lamp, which is used for the rapid ignition and light-up with the lower startup current.

In order to achieve the above or other objects, a startup method for a mercury-free flat-fluorescent lamp is provided, which comprises providing a train of voltage pulses for driving the lamp, and adjusting the duty cycle, the switching frequency, and/or the operation voltage of the driven voltage pulses during the startup period. The above three factors should be properly combined to achieve the rapid ignition, the uniform light-up, and the lower startup current.

In the above-mentioned startup method for the mercury-free flat-fluorescent lamp, the voltage pulse is generated by chopping a DC voltage source or the DC voltage source provided by rectifying and filtering an AC into a square wave voltage, for driving the lamp.

In the above-mentioned startup method for the mercury-free flat-fluorescent lamp, the duty cycle of the voltage pulse is changed during the startup period, wherein the changing process is to increase or decrease the previous duty cycle.

In the above-mentioned startup method for the mercury-free flat-fluorescent lamp, the switching frequency of the voltage pulse is changed during the startup period, wherein the changing process is to increase or decrease the previous switching frequency.

In the above-mentioned startup method for the mercury-free flat-fluorescent lamp, the operation voltage value of the voltage pulse is changed during the startup period, wherein the changing process is to increase the previous operation voltage.

The above-mentioned startup method for the mercury-free flat-fluorescent is also suitable for a burst mode dimming control. During the startup period of the continuous lightening and extinguishing operation for the burst mode dimming control, it is regarded as a single startup, and the three factors which are the duty cycle, the switching frequency, and/or the operation voltage of the voltage pulse can be properly combined to achieve the rapid ignition, the uniform light-up, and the lower startup current.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is the measured voltage and current waveforms of the conventional cold cathode flat fluorescent lamp using sinusoidal waveform.

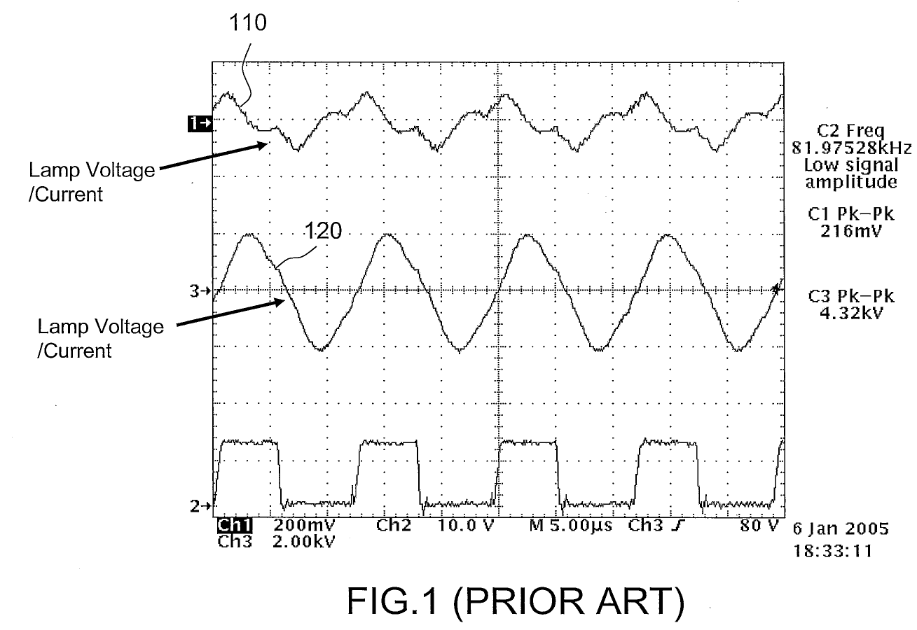

FIG. 2 is the measured voltage and current waveforms of the lamp which using a burst mode dimming for startup process.

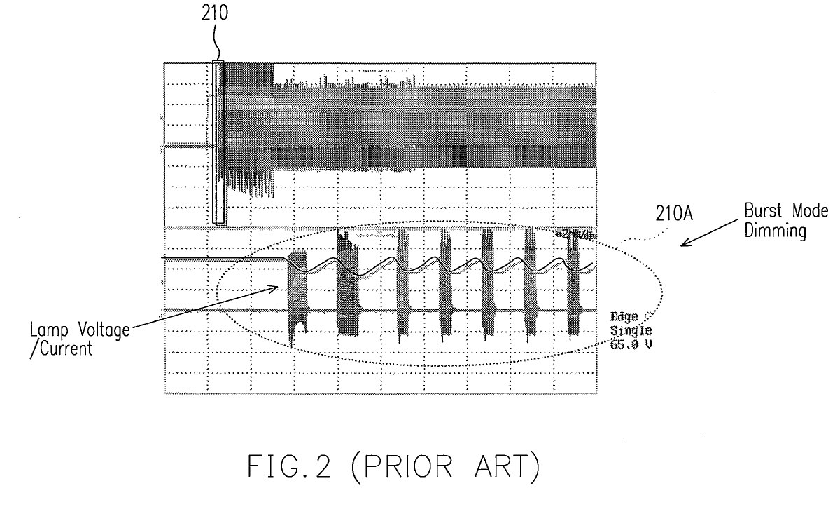

FIG. 3 is the measured voltage and current waveforms of the lamp which using a variable frequency control for startup process.

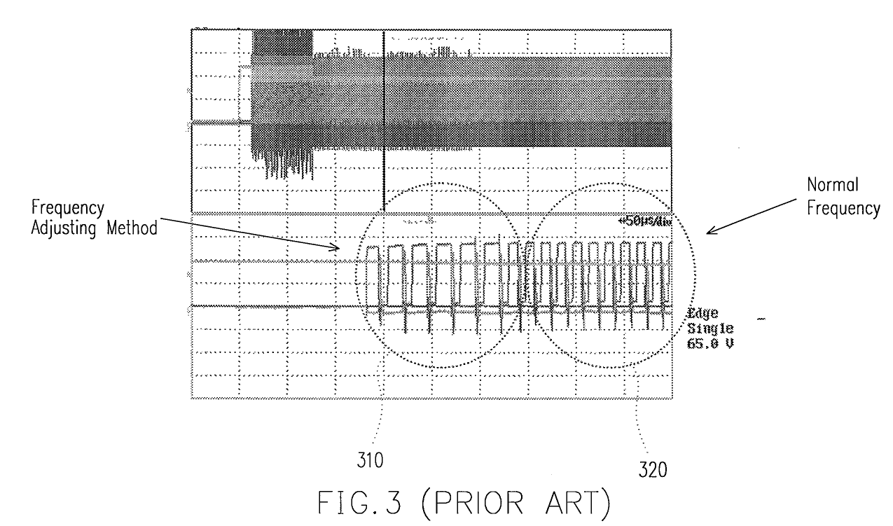

FIG. 4 is a conceptual drawings of the ideal waveforms of the voltage and current of the lamp in the driving method according to the embodiments of the present invention.

FIG. 5 is the measured voltage and current waveforms in driving method of a burst mode dimming control according to the embodiments of the present invention.

### DESCRIPTION OF EMBODIMENTS

In order to make the mercury-free flat-fluorescent lamp with an external electrode to be light up uniformly, an effective startup method is provided in the present invention, such that the mercury-free flat-fluorescent lamp can be ignited and light up rapidly, normally, and uniformly, with lower startup current of the lamp. The primary way of the present invention is to substitute a sine wave voltage with a voltage pulse driving method, and the shape of the lamp voltage applied to the lamp is a square-wave and pulse-type voltage, and that of the current is also a pulse-type current.

The method for lighting up the lamp rapidly, normally, and uniformly provided by the invention will be described below in detail. First, a DC power supply must be chopping into a train of square-wave voltage pulses by adopting a power element or any other methods known by those skilled in the art. Then, the square-wave voltage pulses are raised to a light-up voltage for lighting up, by utilizing a conventional high-frequency transformer, an auto-transformer, or a coupling inductors. After lighting up, the shape of the light-up voltage is a square-wave and pulse-type voltage, and that of the current is also a pulse-type current.

In the startup method provided by the present invention, the current flowing through the lamp is of a pulse-type current, and the current only exists when the lamp voltage is rising or falling. Since the lamp current is of a pulse-type current, in order to achieve the rapid ignition and the uniform light-up, an additional power is required to is uniformly light up the lamp, and the method used is to change the processing time of a power element. As for providing the additional power, the startup method disclosed in the present invention is to change the duty cycle, the switching frequency, and/or the operation voltage. In this startup method, the foregoing three factors are properly combined to achieve the objects of the rapid ignition, of the uniform light up, and with the lower startup current.

As for providing the additional power during the startup period according to the present invention, in an embodiment, through changing the operation voltage, the lamp voltage may be operated above an arc ignition voltage, for a rapid light-up. In an alternative embodiment, through changing the switching frequency, the lamp is normally light up so as to increase the additional power. Furthermore, changing the switching frequency can also be used for perturbing the distribution of plasma inside of lamp, such that the lamp is ignited and light up more uniformly. In still another embodiment, through changing the duty cycle, the startup current required by the lamp can be reduced.

The startup method provided by the present invention is also suitable for a burst mode dimming to reduce a flicker phenomenon when the lamp is operating in dimming control, therefore it is extremely suitable for uniformly lighting up the mercury-free flat-fluorescent lamp with the external electrode.

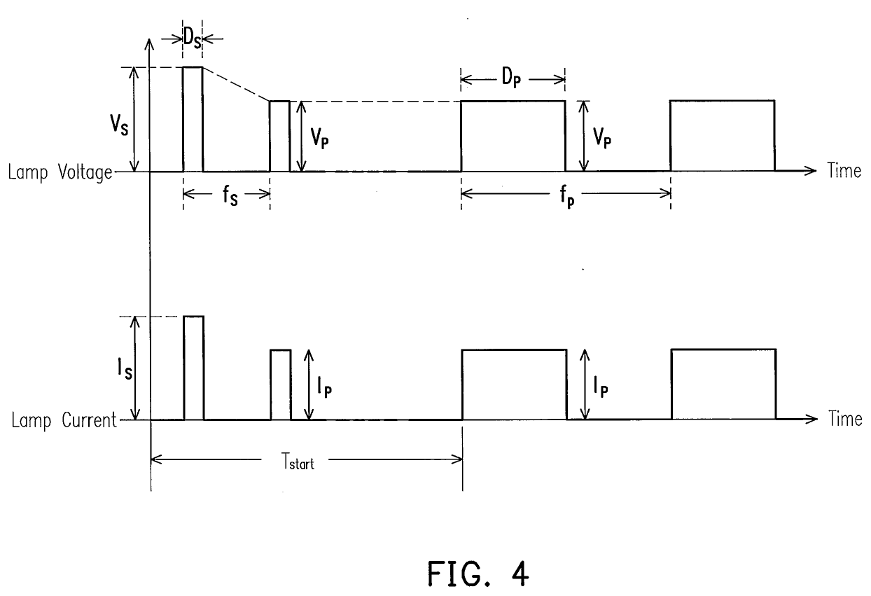

The conceptual drawings of the ideal waveforms of the lamp voltage and current in the embodiments of the startup method according to the present invention is shown in FIG. 4. First, the lamp voltage as a square waveform is provided, and the shape of the current generated therefrom is also a pulse-type current. At a startup time Tₛₜₐᵣₜ, the driving method of this embodiment is to use such three ways as adjusting the duty cycle, adjusting the switching frequency, and/or adjusting the operation voltage in combination. For example, the normal duty cycle Dₚ of the lamp voltage is changed into a smaller duty cycle Dₛ, such as the startup time Tₛₜₐᵣₜ, thus the startup current required by the lamp can be reduced dramatically. This duty cycle Dₛ can be in a range of 5%-80% of the normal duty cycle Dₚ, which is varied depending on the design requirements. Additionally, in an alternative embodiment, the previous normal duty cycle Dₚ also can be changed into a bigger duty cycle increased by about 5%-80%, at the startup time Tₛₜₐᵣₜ.

Additionally, in an embodiment, for example, the switching frequency of the lamp voltage can be changed from the previous normal switching frequency fₚ to a higher frequency fₛ, and meanwhile with an increasing of the frequency, the additional power will be increased accordingly so as to light up the lamp. Furthermore, changing the switching frequency can perturb the distribution of plasma such that the lamp is ignited and light up more uniformly. The previous normal switching frequency fₚ is about 40 KHz-80 KHz, while the frequency is increased by about 5%-80%, and certainly, the increasing may be varied depending on the design requirements. Additionally, in an alternative embodiment, the previous normal switching frequency fₚ also can be changed into a lower frequency decreased by about 5%-80%, at the startup time Tₛₜₐᵣₜ, which is also varied depending on the design requirements.

In still another embodiment, for example, the operation voltage value of the lamp voltage can be changed. For example, as shown in the figures, the operation voltage level of the lamp voltage can be adjusted from the normal level Vₚ into an operation voltage level Vₛ with a longer startup time. Correspondingly, the lamp current value is also increased from the previous current Iₚ into a bigger current Iₛ. In one embodiment, the operation voltage is increased as about 150%-200% of the previous voltage level.

The startup method in the above-mentioned embodiments also can be applied to the burst mode dimming operation. The technique of a burst mode dimming control, also referred as a digital dimming control, is to make the lamp voltage and current to operate fixedly within a certain range, and then to modulate the ON/OFF period of the lamp by utilizing a low frequency dimming (LFD) control to control the pulse, that is, the average luminance of the lamp is in inversely proportional to the work period of a pulse signal, so as to control the average luminance. In general, a dimming controll of 400:1 or higher can be achieved in the current CCFL driving technique. However, the lamp tube has to be repeatedly switched on and off in this method, that is, the startup in each period would result in a high startup voltage and a current surging of the lamp tube. Actually, although a lower average luminance can be obtained in this method similar to a continuous lighting and extinguishing, it is extremely harmful for the electrode of a gas discharge lamp. Therefore, the digital dimming has extremely negative effects on the lifetime of the CCFL lamp tube. Although the flat-fluorescent lamp can be ignited without being preheated, in order to avoid a continuous consumption of the lamp caused by the high startup voltage in this dimming mode, a concept of preheating startup for the conventional fluorescent lamp still can be applied to achieve improvements.

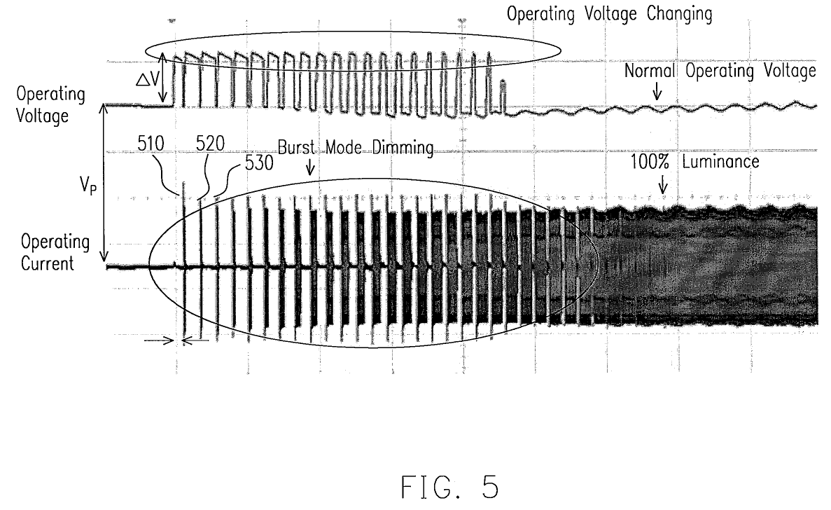

In the startup method provided by the present invention, adjusting the duty cycle, adjusting the switching frequency, and/or adjusting the operation voltage can be employed individually or in combination, so as to achieve the rapid ignition, the uniform light-up, and the lower startup current; and the advantage of the present invention is better revealed in the operation process of the continuous lighting and extinguishing for the burst mode dimming control. However, as for the startup method in the above-mentioned embodiments, shown in FIG. 5, a startup program according to the startup method provided by the present invention will be carried out during each operation process 510, 520, and 530 of the startup period of continuous lighting and extinguishing, as shown in the figure. For example, as shown on top of FIG. 5, the operation voltage level Vₚ of the lamp voltage is adjusted from the normal Vₚ into a higher light-up voltage, that is, the normal voltage Vₚ plus a voltage difference ΔV, and the lamp current is also increased accordingly, which will facilitate a rapid light-up. In one embodiment, the voltage difference ΔV can be 150%-200% of the previous normal voltage Vₚ.

Besides changing the operation voltage level during the startup period, the duty cycle of the lamp voltage also can be changed as shown in FIG. 4, such that the startup current required by the lamp is reduced dramatically. For example, the duty cycle Ds can be changed to be 5%-95% of the normal duty cycle. Additionally, still as shown in FIG. 4, the switching frequency can be changed, for example, be increased by about 20% of the previous normal switching frequency. Changing of the frequency not only can increase the additional power to light up the lamp, but also perturb the distribution of plasma such that the lamp is light up more uniformly. Certainly, all the above-mentioned adjustments can be varied depending on the design requirements.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A startup method for a flat-fluorescent lamp, comprising:
providing a voltage pulse for driving the flat-fluorescent lamp; and
selecting one or a predetermined combination of such three ways as changing the duty cycle of the voltage pulse, changing the switching frequency, and/or changing the operation voltage level, during a startup period, thereby igniting the lamp.

2. The startup method for the flat-fluorescent lamp as claimed in claim 1, further comprising:
providing a DC current source; and
chopping a DC power supply provided by the DC current source into a train of square-wave voltage pulses for driving the lamp.

3. The startup method for the flat-fluorescent lamp as claimed in claim 1, wherein changing the duty cycle of the pulse voltage during the startup period is to increase or decrease the previous duty cycle.

4. The startup method for the flat-fluorescent lamp as claimed in claim 3, wherein the previous duty cycle is increased or decreased by 5%-95% of the previous duty cycle.

5. The startup method for the flat-fluorescent lamp as claimed in claim 1, wherein changing the switching frequency of the voltage pulse during the startup period is to increase or decrease the previous switching frequency.

6. The startup method for the flat-fluorescent lamp as claimed in claim 5, wherein the above-mentioned previous switching frequency is increased or decreased by 5%-80%.

7. The startup method for the flat-fluorescent lamp as claimed in claim 1, wherein changing the operation voltage level of the pulse voltage during the startup period is to increase the previous operation voltage.

8. The startup method for the flat-fluorescent lamp as claimed in claim 7, wherein the above-mentioned previous operation voltage level is increased to be 150%-200% of the previous operation voltage.

9. The startup method for the flat-fluorescent lamp as claimed in claim 1, wherein the startup method is suitable for a burst mode dimming control, and during the startup period of continuous lighting and extinguishing for the burst mode dimming control, the duty cycle of the pulse voltage, the switching frequency of the pulse voltage, and/or the operation voltage level of the pulse voltage are changed.
